(19) United States
(12) Patent Application Publication
(10) Pub. No.: US 2010/0035064 A1
(43) Pub. Date: Feb. 11, 2010

(54) METHOD FOR PREPARATION OF EXTRUDED OBJECTS WITH BRILLIANT GLOSS

(75) Inventors: Kyunggu Nam, Daejeon (KR); Kideog Choi, Daejeon (KR); Jongsung Park, Daejeon (KR)

Correspondence Address: MCKENNA LONG & ALDRIDGE LLP, 1900 K STREET, NW, WASHINGTON, DC, 20006, US

(73) Assignee: LG CHEM , LTD., Seoul (KR)

(21) Appl. No.: 12/448,129

(22) PCT Filed: Sep. 1, 2007
(86) PCT No.: PCT/KR2007/004203

§ 371 Date: Sep. 24, 2009

(30) Foreign Application Priority Data
Dec. 11, 2006 (KR) 10-2006-0125221

(51) Int. Cl. B32B 17/10; B29C 47/92

(52) U.S. Cl. 428/409; 264/176.1

(57) ABSTRACT

Disclosed herein is a method for performing a surface polishing treatment for thermoplastic resin while extrusion-molding the thermoplastic resin, to prepare a highly-glossy extruded product. The method includes performing a surface treatment to give high gloss to a surface of a thermoplastic resin plasticized in an extruder while causing the thermoplastic resin to continuously pass through a die of a relatively-high temperature and a die of a relatively-low temperature in a nozzle region, and controlling the temperature at a trailing end of the high-temperature die and the temperature at a leading end of the low-temperature die such that there is a temperature difference of 30 to 2000C. It is possible to give gloss to an extruded product through a continuous extrusion process without addition of a glazing agent or execution of a separate surface treatment process, and thus, to provide excellent effects in terms of manu-facturing costs and production efficiency.

### TECHNICAL FIELD

The present invention relates to a method for preparing a highly-glossy extruded product, and more particularly to a method for performing a surface polishing treatment for a thermoplastic resin while extrusion-molding the thermoplastic resin. In accordance with the present invention, a surface treatment to give high gloss to a surface of a thermoplastic resin plasticized in an extruder while causing the thermoplastic resin to continuously pass through a die maintained at a relatively-high temperature (high-temperature die) and a die maintained at a relatively-low temperature (low-temperature die) in a region where a nozzle is arranged. The temperature at a trailing end of the high-temperature die and the temperature at a leading end of the low-temperature die are also controlled such that there is a temperature difference of 30 to 200° C. between the temperatures. In accordance with a compression sizing effect obtained by the low-temperature die, the extruded product is subjected to a high pressure while being solidified, so that gloss is given to the surface of the extruded product. Thus, gloss is given to the surface of the extruded product through a continuous extrusion molding process, without addition of a glazing agent or execution of a surface treating process.

### BACKGROUND ART

FIG. 1 schematically illustrates a conventionally-used general extrusion method.

FIG. 2 is a schematic view illustrating an extrusion die and a part of a calibration unit used in the extrusion method of FIG. 1.

Referring to the drawings, the extrusion method includes processes sequentially executed in an extruder 10, an extrusion die 20, a calibration unit 30, a pultrusion unit 40, and a cutter 50 arranged in this order in an advancing direction of an extruded product.

Raw materials for an extruded product are mixed by an agitator 11, and then are plasticized. The resultant plasticized material is extruded through the extruder after being melted in the extruder 10. In order to form an extruded product having a certain shape, the extrusion-molding material passes through the extrusion die 20, to which an external heater 22 is mounted. Thus, an extruded product in a high-temperature state emerges from a nozzle 21 of the extrusion die 20. The extruded product emerging from the extrusion die 20 in a high-temperature state then passes through the calibration unit 30, in order to cool and solidify the extruded product, and thus, to maintain the profile of the extruded product. The solidified extruded product is cut into a desired length by the cutter 50 after passing through the pultrusion unit 40. Thus, desired extruded products can be manufactured.

However, such an extruded product has no or little gloss at the surface thereof. For this reason, various methods such as addition of a glazing agent or execution of a surface treatment process are conventionally used, in order to give high gloss to the surface of the extruded product.

For example, there is a conventional method in which heating wires are arranged at the outlet end of a die, to conform the profile of an extruded product. However, this method has a problem in that extrusion errors may occur due to overheat. As other conventional methods, a method for polishing the surface of an extruded product or a method for coating a highly-glossy material over the surface of an extruded product are known. In implementing these methods, however, it is necessary to use a surface treating device. For this reason, an increase in manufacturing costs and a considerable degradation in productivity occur due to the additional process. Furthermore, poor-quality products may be produced because the coating formed in accordance with the surface treatment is non-uniform.

Korean Patent No. 0538773 discloses a technique relating to an extrusion molding system in which an auxiliary mold member provided with uniformly-spaced air passages communicating with the external of the system is coupled to an extruding member such that gas internally generated during a foaming/molding process is immediately discharged to the external of the system, together with air, in order to achieve an efficiency enhancement in a high foaming process. This system also includes a sizing member in which cooling water is circulated through cooling water circulation holes, simultaneously with execution of the foaming/molding process. Accordingly, the sizing member rapidly cools the outer surface of a molded product, and thus, achieves a desired surface treatment for the molded product.

However, the above-mentioned technique has no concrete disclosure as to the method for rapidly cooling the outer surface of the molded product. In accordance with experiments conducted by the inventors of the present invention, it was confirmed that, in the above-mentioned extrusion molding system in which the sizing member is arranged at an upstream end of the molding member, a very-gentle temperature profile is established due to conduction of heat, so that it is impossible to provide high gloss to the extruded product even when surface treatment is carried out for a certain portion of the extruded product.

Also, U.S. Patent Published Application No. 2004-0159966 discloses a method for manufacturing an extrusion molding with a smooth surface. This method is implemented using an apparatus including an extrusion die having a molten resin flow channel and a sizing device having a shaping flow channel with a smooth inner wall face. The extrusion die and sizing device are connected to each other. One or more heat conducting members are mounted to the extrusion die in a vertical direction of the molten resin flow channel. The distal end of the heat conducting member is penetrated through the shaping flow channel, and tapered. In accordance with the disclosed method, a molten portion remains in the molding material when the molding material passes the distal end portion of the heat conducting member. Accordingly, when the molding material is solidified while passing through the shaping flow channel of the sizing device, the surface of the molding material is pressed against the inner wall face of the shaping flow channel due to an expansion pressure of the molten portion, to form a smooth outer surface of the molding.

However, this technique cannot give high gloss to the surface of the extruded product. That is, since the extrusion die and sizing device are directly connected, it is impossible to completely prevent conduction of heat in spite of the presence of the heat insulating portion. For this reason, the extruded product has a very gentle temperature gradient, so that the extruded product cannot have a highly-glossy surface. Although the above-mentioned technique discloses an apparatus in which a heat conducting member is mounted in the shaping flow channel, the apparatus is very complex.

Furthermore, the heat conducting member degrades the flowability of the extrusion molding, so that the physical properties of the finally-extruded product may be non-uniform. In addition, it is substantially difficult to stably mount the heat conducting member within the shaping flow channel. An increase in installation costs also occurs.

Due to such problems, the above-mentioned technique has a limitation in practical use.

A technique for achieving an increase in extrusion speed is also disclosed in Japanese Patent Unexamined Publication No. 2001-113587. In accordance with the disclosed technique, the cross-sectional area of a resin channel at a point where a molten resin begins to solidify is smaller than the cross-sectional area of a finally-extruded product.

As a result, the flow rate of a molten resin portion present inside the solidified layer of the resin is higher than the flow rate of the solidified layer of the resin flowing along the wall surface of a sizing device defined with the resin channel while being pressed against the wall surface. Thus, an increase in extrusion speed is achieved.

However, this technique has various problems of a degradation in the flow characteristics of the extrusion molding material, a complex process, and an increase in installation costs in that it is necessary to separately form the resin channel, in order to reduce the cross-sectional area of the resin channel.

Therefore, there has been a high demand for a technique capable of giving high gloss to the surface of an extruded product in accordance with a continuous extrusion process while preventing waste of space and manufacturing costs and achieving an enhancement in production efficiency.

### DISCLOSURE OF INVENTION

### Technical Problem

Therefore, the present invention has been made to solve the above problems, and other technical problems that have yet to be resolved.

After active research and various repeated experiments, the inventors of the present invention found the following facts in association with a method for performing a surface polishing treatment for a thermoplastic resin while extrusion-molding the thermoplastic resin. That is, it is possible to give gloss to an extruded product in accordance with a continuous extrusion process, and thus, to achieve a reduction in manufacturing costs and an enhancement in production efficiency, by performing surface treatment to give high gloss to the surface of a thermoplastic resin plasticized in an extruder while causing the thermoplastic resin to continuously pass through a high-temperature die and a low-temperature die in a region where a nozzle is arranged, and controlling the temperature at the trailing end of the high-temperature die and the temperature at the leading end of the low-temperature die such that there is a temperature difference of 30 to 200° C. between the temperatures.

### Technical Solution

The present invention provides a method for performing a surface polishing treatment for a thermoplastic resin while extrusion-molding the thermoplastic resin which comprises performing a surface treatment to give high gloss to the surface of a thermoplastic resin plasticized in an extruder while causing the thermoplastic resin to continuously pass through a die maintained at a relatively-high temperature (high-temperature die) and a die maintained at a relatively-low temperature (low-temperature die) in a region where a nozzle is arranged, and controlling the temperature at the trailing end of the high-temperature die and the temperature at the leading end of the low-temperature die such that there is a temperature difference of 30 to 200° C. between the temperatures.

In accordance with the method of the present invention, the low-temperature die generates a compression sizing effect in the procedure in which the extruded product passes through the nozzle, due to the temperature difference. In accordance with the compression sizing effect, the extruded product is subjected to a high pressure while being abruptly solidified, so that gloss is given to the surface of the extruded product.

Thus, gloss is given to the surface of the extruded product through a continuous extrusion molding process, without addition of a glazing agent or execution of a surface treating process. Accordingly, it is possible to achieve a reduction in manufacturing costs and an enhancement in production efficiency.

That is, the extruded product is abruptly solidified between the temperature difference between the high-temperature die and the low-temperature die. As a result, the density of the extruded product in the low-temperature die, ρ_{H}, is higher than the density of the extruded product in the high-temperature die, ρ_{C}. Accordingly, the flow rate of the extruded product in the high-temperature die, V_{H}, is lower than the flow rate of the extruded product in the low-temperature die, V_{C}. As a result, an abrupt solidification occurs in the extruded product, starting from the surface of the extruded product in contact with the low-temperature die, and a pressure is generated due to a high shear force applied to the solidified surface of the extruded product. Thus, a high pressure is applied to the extruded product in the low-temperature die. It is thought that gloss is given to the surface of the extruded product due to a kind of pressing force.

In accordance with the present invention, there is a temperature difference of 30 to 200° C. between the temperature at the trailing end of the high-temperature die and the temperature at the leading end of the low-temperature die. When the temperature difference is less than 30° C., insufficient solidification occurs at the outer surface of the extruded product. In this case, it is impossible to obtain desired gloss. On the other hand, when the temperature difference is more than 200° C., the extruded product is abruptly solidified. In this case, it is difficult to execute the manufacturing process.

A heater may be provided at the trailing end of the high-temperature die, in order to prevent a temperature reduction. The heater may be arranged inside the high-temperature die. Alternatively, the heater may be arranged inside and outside the high-temperature die. There is no limitation on the heater. For example, a general electrical heater may be used for the heater.

The temperature at the trailing end of the high-temperature die may be appropriately adjusted in accordance with the kind of the thermoplastic resin to be extruded. Preferably, this temperature is 150 to 250° C. When the temperature at the trailing end of the high-temperature die is less than 150° C., the extruded product is too slowly solidified to have a high density. In this case, the extruded product cannot have surface gloss. On the other hand, when the temperature exceeds 250° C., the quality of the thermoplastic resin may be degraded.

Preferably, a cooler is provided at the leading end of the low-temperature die, in order to prevent a temperature increase. Similarly to the heater, the cooler may be formed inside the low-temperature die, or may be formed inside and outside the low-temperature die. There is no limitation on the cooler. For example, a pipe line, through which a coolant flows, may be used for the cooler.

The temperature at the leading end of the low-temperature die can be appropriately adjusted in accordance with the kind of the thermoplastic resin. Preferably, this temperature is maintained to be slightly higher than the melting point or softening point of the thermoplastic resin. More preferably, the temperature may be 40 to 150° C. When the temperature at the leading end of the low-temperature die is less than 40° C., an abrupt solidification occurs. In this case, it is difficult to execute the manufacturing process. On the other hand, when the temperature exceeds 150° C., the temperature difference between the low-temperature die and the high-temperature die is too small to achieve substantial solidification of the extruded product. In this case, it is impossible to obtain desired surface gloss.

Preferably, the high-temperature die and low-temperature die may be configured to have an integral structure constituting a single extrusion die. This structure is advantageous in that it is possible to minimize the length of a temperature transition zone.

One or more low-temperature dies may be used. For example, where the discharge speed of the molten portion of the thermoplastic resin increases, two or more low-temperature dies may be used to increase the die contact time of the extruded product.

Preferably, the temperature variation in each of the high-temperature die and low-temperature die is within ±5° C. More preferably, the temperature variation is within ±2° C. When the temperature variation is beyond the range of ±5° C., it is impossible to obtain a uniformly-extruded product. In this case, the mechanical properties of the extruded product are degraded.

In a preferred embodiment of the present invention, a temperature transition zone is present between the high-temperature die and the low-temperature die. The temperature transition rate in the temperature transition zone in a process advancing direction may be 2 to 40° C./mm in accordance with a calculation based on the following Expression (1). Meanwhile, it is preferred that the temperature transition zone have a length of 1 to 150 mm.

T_{L}=(T_{H}−-T_{C})/L (1)

In Expression (1), “T_{L}” represents a temperature transition rate, “T_{H}” represents the temperature at the trailing end of the high-temperature die, “T_{C}” represents the temperature at the leading end of the low-temperature die, and “L” represents the length of the temperature transition zone.

An abrupt temperature variation occurs in the temperature transition zone present between the high-temperature die and the low-temperature die. This temperature transition zone functions to prevent heat exchange occurring between the high-temperature die and the low-temperature die. When the temperature transition zone has a higher temperature transition rate, the extruded product can be solidified at a higher density. Accordingly, it is more effective for the temperature transition zone to have a higher temperature transition rate in giving surface gloss to the extruded product.

When the length of the temperature transition zone exceeds 150 mm, or the temperature transition rate is less than 2° C./mm, the temperature transition occurring between the high-temperature die and the low-temperature die is slow, thereby causing a slow solidification of the extruded product. In this case, the density of the extruded product is too low to give desired surface gloss.

Meanwhile, it is more effective for the high-temperature die and low-temperature die to have an integral structure constituting a single extrusion die in that it is possible to minimize the length of a temperature transition zone.

There is no specific limitation on the thermoplastic resin, as long as the thermoplastic resin is extrudable. Preferably, the thermoplastic resin includes one or more polymers selected from the group consisting of acrylonitrile-butadiene-styrene (ABS) copolymer, polycarbonate (PC), polyvinyl chloride (PVC), polystyrene (PS), ply-methylmethacrylate (PMMA), polyester, polypropyrene, and nylon.

The thermoplastic resin includes a non-foam or a foam. When a foam is manufactured using an extruding/calibrating system according to the present invention, the thermoplastic resin may be a micro foam. As disclosed in Korean Patent Application No. 2005-115637 in the name of the applicant, the micro foam may have a high density at the skin portion thereof and mechanical properties similar to those of a non-foam sheet, because the structure of pores in the skin portion of the micro foam is finer than that of the core portion of the micro foam. The content of the above-described patent application is incorporated in the present invention, for reference.

In a preferred embodiment of the present invention, the method may further comprise a pultrusion process for pultrusing the extruded product emerging from the extruder by a pultrusion unit. Since the pultrusion process is well known in the art, no further description thereof will be given.

Preferably, the processing speed of the pultrusion unit is controlled to finely adjust the surface gloss of the extruded product. The adjustment of the surface gloss through the control for the processing speed of the pultrusion unit means fine adjustment of the high gloss obtained by the combination of the high-temperature die and low-temperature die within a desired range.

The present invention also provides an extruded product having a surface gloss of 45 to 95 which is manufactured in accordance with the above-described method.

The graph depicting the physical property range of the extruded product having a surface gloss of 45 to 95 is shown in FIG. 5.

In FIG. 5, the value L on the horizontal axis represents the length of the temperature transition zone, and the value ΔT on the vertical axis represents the temperature difference between the trailing end of the high-temperature die and the leading end of the low-temperature die. Referring to FIG. 5, the physical property range is divided into portions A and B by a critical line. The portion A represents the physical property range of an extruded product prepared in accordance with a general extrusion molding method, whereas the portion B represents the physical property range of an extruded product prepared in accordance with the extrusion molding method of the present invention. Although the critical line is shown in the form of a straight line in FIG. 5, for the convenience of the explanation, it is not limited thereto. The shape of the critical line may vary in accordance with factors such as the kind of the thermoplastic resin and/or the cross-sectional area of the extruding tube. For example, the critical line may have a straight line or a curved line.

Preferably, the extruded product according to the present invention has physical properties defined by a portion B′ of the physical property range in FIG. 5. The above-described surface gloss range of the extruded product also belongs to the portion B′. As to extruded products belonging to a portion B″ corresponding to a range in which the value L is excessively small, and the value ΔT is excessively large or corresponding to a range in which both the value L and the value ΔT are excessively large, there is a problem in that it is difficult to implement an extrusion molding apparatus for these extruded products. There is another problem in that the extruded products are abruptly solidified, so that the discharge speed thereof is greatly reduced, thereby causing a great reduction in productivity. On the other hand, extruded products belonging to a portion B′″ corresponding to a range in which the value L is excessively large exhibit considerably-degraded physical properties because the density thereof is non-uniform.

Now, preferred embodiments of the present invention will be described in detail with reference to the accompanying drawings. It should be noted, however, that the scope of the present invention is not limited by the illustrated embodiments.

FIG. 3 schematically illustrates a method for preparing a highly-glossy extruded product in accordance with an exemplary embodiment of the present invention. FIG. 4 is a schematic view illustrating parts of an extrusion die and a calibration unit used in the extrusion method shown in FIG. 3.

As shown in FIGS. 3 and 4, in accordance with the method of the present invention, a highly-glossy extruded product can be prepared by an apparatus in which an extruder 100, an extrusion die 200, a calibration unit 300, a pultrusion unit 400, and a cutter 50 arranged in this order in an advancing direction of an extruded product.

In detail, raw materials for an extruded product are mixed by an agitator 110, and then are melted and plasticized while passing through the extruder 100. The resultant plasticized material is extruded into a certain shape through the extrusion die 200.

The extrusion die 200 includes a high-temperature die 250 mounted with an inner heater 200, and a low-temperature die 260 connected to the high-temperature die 250 for continuous extrusion of a molded product. The low-temperature die 260 includes a cooler 230 mounted inside the low-temperature die 260.

A temperature transition zone is present between the high-temperature die 250 and the low-temperature die 260. An abrupt solidification occurs due to an abrupt temperature gradient of the temperature transition zone, stating from the surface of an extruded product in contact with the low-temperature die 260. As a result, the surface of the extruded product is solidified while having a high density, and a pressure is generated due to a high shear force applied to the solidified surface of the extruded product. Due to the solidification of the extruded product as described above, there is an extrusion speed difference between the high-temperature die 250 and the low-temperature die 260. As a result, a high pressure is applied to the extruded product, so that high gloss is given to the surface of the extruded product due to a kind of pressing force.

When it is selectively necessary to additionally cool and solidify the extruded product, the extruded product may pass through the calibration unit 300 after emerging from the low-temperature die 260. The calibration unit 300 may have a short processing length of about 2 m or less. Thus, it is possible to prevent a spatial waste of the extrusion system, and to reduce the manufacturing costs. Since the processing length is reduced, the extrusion speed increases. As a result, the productivity can be highly enhanced. Meanwhile, a coolant circulator 310 is connected to the low-temperature die 260 and/or the calibration unit 300. Accordingly, in accordance with circulation of a coolant, the extruded product can be cooled and solidified.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a conventional extruding/calibrating system;

FIG. 2 is a schematic view illustrating an extrusion die and a part of a calibration unit included in the extruding/calibrating system of FIG. 1;

FIG. 3 is a schematic view illustrating an extruding/calibrating system according to an exemplary embodiment of the present invention;

FIG. 4 is a schematic view illustrating an extrusion die and a part of a calibration unit included in the extruding/calibrating system of FIG. 3; and

FIG. 5 is a graph depicting the physical property range of an extruded product according to an exemplary embodiment of the present invention.

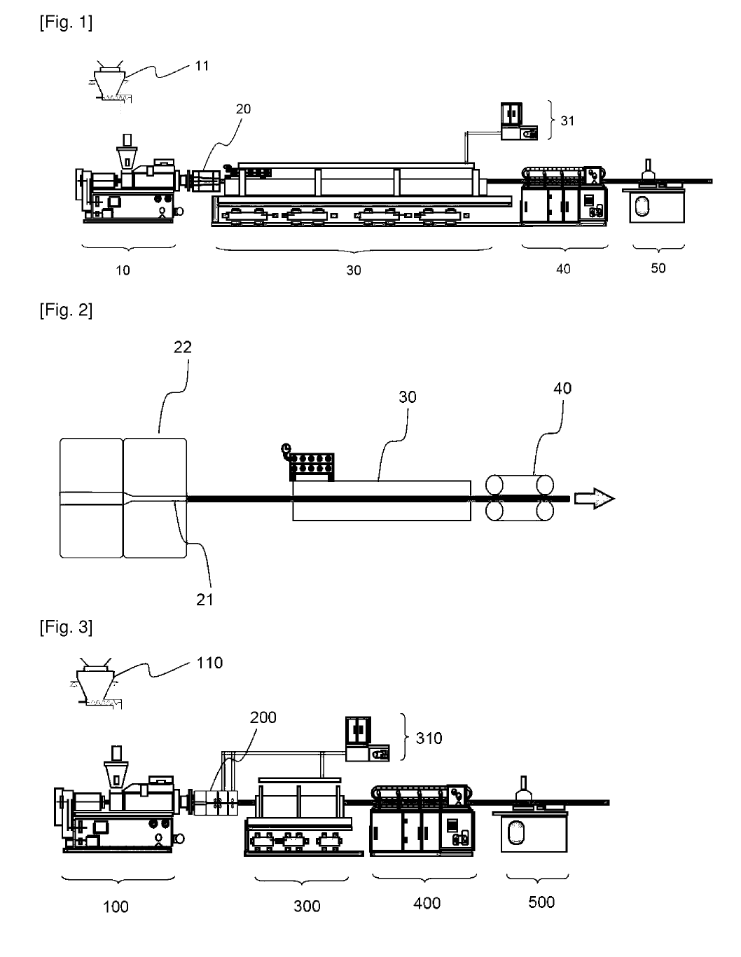

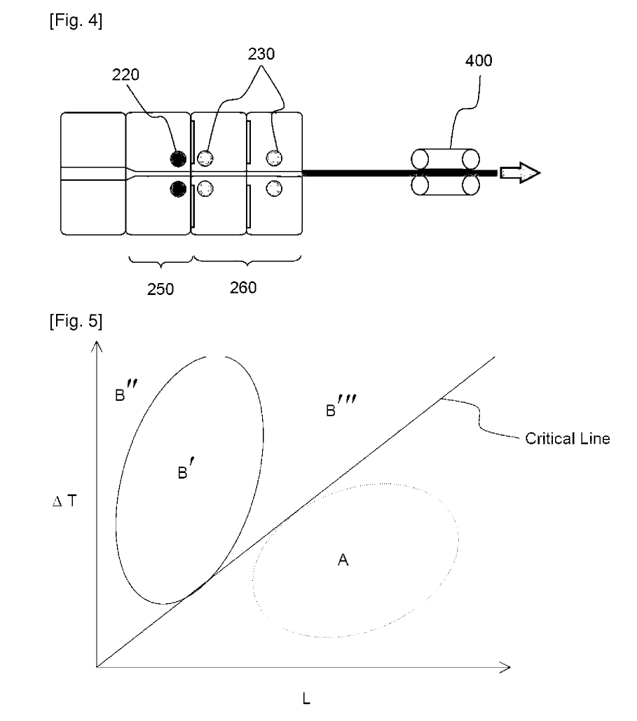

### MODE FOR THE INVENTION

Hereinafter, the present invention will be described through examples, but the scope of the present invention is not limited to those examples.

### EXAMPLES 1 to 4

An extrusion apparatus for extrusion-molding a thermoplastic resin was prepared by mounting an extrusion die having an integral structure constituted by a temperature-controllable high-temperature die, a temperature transition zone, and a low-temperature die to a bi-axial extruder, together with an adapter. In this case, the high-temperature die had a length of 125 mm, the temperature transition zone had a length of 27 mm, and the low-temperature die had a length of 40 mm. 98 weight parts of a hard polyvinyl chloride (PVC) compound (manufactured by LG Chemical Co., Ltd.) was supplied to the extruder, to completely plasticize the PVC. Thereafter, 2 weight parts of nitrogen was supplied to a barrel of the extruder, using a high-pressure pump. Thus, a single-phase mixture was molded to manufacture a PVC sheet having a thickness of 2 mm and a width of 100 mm.

The conditions of the extruder were set to vary the temperature of the barrel in the order of 190° C.-180° C.-175° C. Also, the adapter was maintained at a temperature of 130° C.

The conditions of the high-temperature die, temperature transition zone, and low-temperature die are described in the following Table 1.

### COMPARATIVE EXAMPLE 1

A PVC sheet was manufactured in the same manner as Example 1, except that a conventional extrusion die, which only includes a high-temperature die without including an extrusion die having an integral structure constituted by a temperature-controllable high-temperature die, a temperature transition zone, and a low-temperature die, and a cooling process was carried out using a calibration unit having a length of about 4 m. The conditions of the high-temperature die are described in the following Table 1.

TABLE 1

| | | | | | | | Die Temp. (° C.) | | | | | Extrusion |
|---|---|---|---|---|---|---|---|---|---|---|---|---|
| | Barrel Temp. (° C.) | | | | | | HT Die | | LT Die | | Discharge | Speed |
| | Cy1 | Cy2 | Cy3 | Cy4 | Cy5 | Ad | 1 | 2 | 1 | 2 | Temp. (° C.) | (m/min) |
| Ex. 1 | 190 | 180 | 180 | 180 | 175 | 130 | 185 | 185 | 60 | 50 | 85 | 3 |
| Ex. 2 | 190 | 180 | 180 | 180 | 175 | 130 | 185 | 185 | 50 | 40 | 65 | 3.2 |
| Ex. 3 | 190 | 180 | 180 | 180 | 175 | 130 | 185 | 185 | 40 | 30 | 55 | 3.2 |
| Ex. 4 | 190 | 180 | 180 | 180 | 175 | 130 | 185 | 185 | 30 | 20 | 40 | 3.4 |

| | | | | | | | | | | | |
|---|---|---|---|---|---|---|---|---|---|---|---|
| Comp. | 190 | 180 | 180 | 180 | 175 | 130 | 185 | 185 | No | 180 | 3 |
| Ex. 1 | | | | | | | | | Cooling | | |

### EXPERIMENTAL EXAMPLE 1

The extrusion speed in the PVC sheet extruding process was measured for the above-described Examples 1 to 4 and Comparative Example 1. The results of the measurement are described in the above Table 1.

Referring to Table 1, it can be seen that the extrusion speeds in Examples 1 to 4 using no calibration unit are equal to that of Comparative Example 1, or are enhanced over that of Comparative Example 1 by about 10 to 15%.

### EXPERIMENTAL EXAMPLE 2

A gloss measurement was conducted for the PVC sheets of Examples 1 to 4 and the PVC sheet of Comparative Example 1, using a mirror surface gloss measurement method according to KS L 2405. The results of the measurement are described in the following Table 2. For the gloss measuring device, a micro-tri-gloss meter manufactured by Gardner Company was used.

TABLE 2

| | Gloss | | |
|---|---|---|---|
| | 20° | 60° | 85° |
| Example 1 | 43 | 73 | 87 |
| Example 2 | 43 | 70 | 85 |
| Example 3 | 40 | 67 | 84 |
| Example 4 | 40 | 66 | 88 |
| Comp. Ex. 1 | 18 | 45 | 82 |

As shown in Table 2, the PVC sheets of Examples 1 to 4 exhibited a gloss higher than the PVC sheet of Comparative Example 1 at all of 20°, 60°, and 85°. In particular, the gloss measured at 20° was exhibited to be higher than that of the conventional PVC sheet by two times or more.

Thus, it was confirmed that the method for manufacturing a highly-glossy extruded product in accordance with the present invention could give surface gloss to an extruded product through a continuous extrusion process without using a separate polishing process, and thus, to achieve an enhancement in extrusion speed and a great enhancement in production efficiency.

### INDUSTRIAL APPLICABILITY

As apparent from the above description, the method for manufacturing a highly-glossy extruded product in accordance with the present invention can give gloss to an extruded product through a continuous extrusion process without addition of a glazing agent or execution of a separate surface treatment process. Accordingly, the method of the present invention and the extruded product manufactured using the same can provide excellent effects in terms of manufacturing costs and production efficiency. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for preparing a highly-glossy extruded product, comprising:
performing a surface treatment to give high gloss to a surface of a thermoplastic resin plasticized in an extruder while causing the thermoplastic resin to continuously pass through a high-temperature die maintained at a relatively-high temperature and a low-temperature die maintained at a relatively-low temperature in a region where a nozzle is arranged;
and controlling a temperature at a trailing end of the high-temperature die and a temperature at a leading end of the low-temperature die such that there is a temperature difference of 30 to 200° C. between the temperatures.

2. The method according to claim 1, wherein a heater is arranged at the trailing end of the high-temperature die, to prevent a reduction in temperature.

3. The method according to claim 1, wherein the temperature at the trailing end of the high-temperature die is 150 to 250° C.

4. The method according to claim 1, wherein a cooler is arranged at the leading end of the low-temperature die, to prevent an increase in temperature.

5. The method according to claim 1, wherein the temperature at the leading end of the low-temperature die is 40 to 150° C.

6. The method according to claim 1, wherein each of the high and low-temperature dies has a temperature variation of 5° C.

7. The method according to claim 1, wherein a temperature transition zone is present between the high-temperature die and the low-temperature die, and the temperature transition zone has a temperature transition rate of 2 to 40° C./mm in a process advancing direction, the temperature transition rate being calculated based on the following Expression (I):
T_{L}=(T_{H}−T_{C})/L (I)
where, “T_{L}” represents the temperature transition rate, “T_{H}” represents the temperature at the trailing end of the high-temperature die, “T_{C}” represents the temperature at the leading end of the low-temperature die, and “L” represents the length of the temperature transition zone.

8. The method according to claim 7, wherein the length of the temperature transition zone is 1 to 150 mm.

9. The method according to claim 1, wherein the thermoplastic resin comprises one or more polymers selected from the group consisting of acrylonitrilebutadiene-styrene (ABS) copolymer, polycarbonate (PC), polyvinyl chloride (PVC), polystyrene (PS), plymethylmethacrylate (PMMA), polyester, polypropyrene, and nylon.

10. The method according to claim 1, further comprising:
pultrusing the extruded product emerging from the extruder by a pultrusion unit while controlling the processing speed of the pultrusion unit to finely adjust the surface gloss of the extruded product.

11. The method according to claim 1, wherein a foaming agent is added to the thermoplastic resin, to prepare an extruded micro foam product.

12. An extruded product prepared by a method according to claim 1, wherein the extruded product has a surface gloss of 45 to 95.
